(19) United States
(12) Patent Application Publication
(10) Pub. No.: US 2025/0113042 A1
(43) Pub. Date: Apr. 3, 2025

(54) VIDEO PROCESSING METHOD, DEVICE AND STORAGE MEDIUM

(71) Applicants: Beijing Zitiao Network Technology Co., Ltd., Beijing (CN); Peking University, Beijing (CN)

(72) Inventors: Mengxi GUO, Beijing (CN); Fei ZHAO, Beijing (CN); Kang LIU, Beijing (CN); Shijie ZHAO, Beijing (CN); Hongbin LIU, Beijing (CN); Junlin LI, Los Angeles, CA (US); Li ZHANG, Los Angeles, CA (US)

(21) Appl. No.: 18/895,363

(22) Filed: Sep. 24, 2024

(30) Foreign Application Priority Data
Sep. 28, 2023 (CN) 202311284018.4

(51) Int. Cl. H04N 19/149; H04N 19/107; H04N 19/119; H04N 19/124; H04N 19/13; H04N 19/154; H04N 19/159; H04N 19/176; H04N 19/503; H04N 19/593; H04N 19/61; H04N 19/85

(52) U.S. Cl. CPC H04N 19/149; H04N 19/107; H04N 19/119; H04N 19/124; H04N 19/13; H04N 19/154; H04N 19/159; H04N 19/176; H04N 19/503; H04N 19/593; H04N 19/61; H04N 19/85

(57) ABSTRACT

The present disclosure provides a video processing method, apparatus and electronic device. The method includes: acquiring a first video; processing the first video based on a video processing model to obtain a second video, wherein a training stage of the video processing model includes a differentiable encoder which is configured to simulate quantization and encoding processes performed by an encoder on a video, and the differentiable encoder is capable of performing gradient backpropagation; and encoding the second video.

### CROSS-REFERENCE TO RELATED APPLICATION

This application claims the priority to and benefits of Chinese Patent Application No. CN202311284018.4, filed on Sep. 28, 2023. The aforementioned patent application is hereby incorporated by reference in its entirety.

### TECHNICAL FIELD

Embodiments of the present disclosure relate to the technical field of video processing, and in particular, to a video processing method, apparatus, electronic device and storage medium.

### BACKGROUND

A server may perform pre-processing on a video before sending the video to a terminal device. Accordingly, a playing effect of the video is improved.

At present, a server may perform pre-processing on a video based on a video processing model. For example, the server may perform super-resolution processing on the video based on a trained video super-resolution model, thereby increasing the definition of the video. However, before sending the processed video to the terminal device, the server also needs to encode the video. Part of information in the video may be lost after encoding, which in turn results in poor accuracy of video processing.

### SUMMARY

The present disclosure provides a video processing method, apparatus, electronic device and storage medium to solve one or more technical problems in the prior art.

In a first aspect, the present disclosure provides a video processing method, comprising: acquiring a first video; processing the first video based on a video processing model to obtain a second video, wherein a training stage of the video processing model comprises a differentiable encoder which is configured to simulate quantization and encoding processes performed by an encoder on a video, and the differentiable encoder is capable of performing gradient backpropagation; and encoding the second video.

In a second aspect, the present disclosure provides a video processing apparatus, comprising an acquisition module, a processing module, and an encoding module, wherein the acquisition module is configured to acquire a first video; the processing module is configured to process the first video based on a video processing model to obtain a second video, wherein a training stage of the video processing model comprises a differentiable encoder which is configured to simulate quantization and encoding processes performed by an encoder on a video, and the differentiable encoder is capable of performing gradient backpropagation; and the encoding module is configured to encode the second video.

In a third aspect, the present disclosure provides an electronic device, comprising: a processor and a memory, wherein the memory stores computer-executable instructions; and wherein the computer-executable instructions stored on the memory, when executed by the processor, cause the processor to perform the video processing method as described in the first aspect and any video processing method that may be involved in the first aspect.

In a fourth aspect, the present disclosure provides a non-transitory computer-readable storage medium, storing computer-executable instructions which, when executed by a processor, cause the processor to implement the video processing method as described in the first aspect and any video processing method that may be involved in the first aspect.

### BRIEF DESCRIPTION OF DRAWINGS

In order to more clearly illustrate the technical solutions in the embodiments of the present disclosure or in the prior art, a brief introduction to the drawings referenced in the description of the embodiments or the prior art will be provided hereinafter. It is obvious that the drawings described below are some of the embodiments of the present disclosure. For those skilled in the art, other drawings can be obtained based on these drawings without creative efforts.

FIG. 1 is a schematic diagram of an application scenario provided by an embodiment of the present disclosure;

FIG. 2 is a flowchart of a video processing method provided by an embodiment of the present disclosure;

FIG. 3 is a structural schematic diagram of a training stage of a video processing model provided by an embodiment of the present disclosure;

FIG. 4 is a schematic diagram of a method of training a video processing model provided by an embodiment of the present disclosure;

FIG. 5 is a schematic diagram of an image block provided by an embodiment of the present disclosure;

FIG. 6 is a schematic diagram of determining a plurality of candidate image blocks provided by an embodiment of the present disclosure;

FIG. 7 is a schematic diagram of a training process of a video processing model provided by an embodiment of the present disclosure;

FIG. 8 is a schematic diagram of an image encoding method provided by an embodiment of the present disclosure;

FIG. 9 is a schematic diagram of a process of determining a second residual image provided by an embodiment of the present disclosure;

FIG. 10 is a schematic diagram of a process of generating a second image provided by an embodiment of the present disclosure;

FIG. 11 is a structural schematic diagram of a video processing apparatus provided by an embodiment of the present disclosure; and

FIG. 12 is a structural schematic diagram of an electronic device provided by an embodiment of the present disclosure.

### DETAILED DESCRIPTION

Exemplary embodiments will be described in detail herein, and examples thereof are represented in the accompanying drawings. When the following descriptions relate to the accompanying drawings, unless otherwise stated, same numerals in different accompanying drawings represent same or similar elements. Implementations described in the following exemplary embodiments do not represent all implementations consistent with the present disclosure. On the contrary, the implementations are merely examples of apparatuses and methods that are described in detail in the appended claims and consistent with some aspects of the present disclosure.

For better understanding, concepts involved in the embodiments of the present disclosure are explained below.

An electronic device is a device having wireless receiving and sending functions. The electronic device may be deployed on land, e.g., in a room or outdoors, held in hand, worn, or on a vehicle. The electronic device may be a mobile phone, a Pad, a computer with wireless receiving and sending functions, a virtual reality (VR) electronic device, an augmented reality (AR) electronic device, a wireless terminal in industrial control, a vehicular electronic device, a wireless terminal in self driving, a wireless electronic device in remote medical, a wireless electronic device in smart grid, a wireless electronic device in transportation safety, a wireless electronic device in smart city, a wireless electronic device in smart home, a wearable electronic device, or the like. The electronic device involved in the embodiments of the present disclosure may also be referred to as a terminal, user equipment (UE), an access electronic device, a vehicular terminal, an industrial control terminal, a UE unit, a UE station, a mobile radio station, a mobile station, a distant station, a remote electronic device, a mobile device, a UE electronic device, a wireless communication device, a UE proxy, a UE apparatus, or the like. The electronic device may also be stationary or movable.

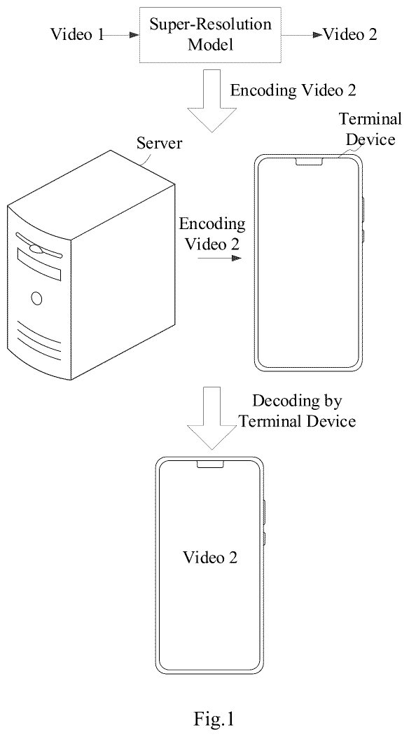

An application scenario of an embodiment of the present disclosure is described below with reference to FIG. 1.

FIG. 1 is a schematic diagram of an application scenario provided by an embodiment of the present disclosure. Referring to FIG. 1, a server, a terminal device, and video 1 are involve. The server may include a super-resolution model. The server may process the video 1 based on the super-resolution model to obtain video 2 after super-resolution processing (the definition of the video 2 is greater than that of the video 1). The server may encode the video 2 to obtain a code of the video 2. The server may send the code of the video 2 to the terminal device. After receiving the code of the video 2, the terminal device may decode the code of the video 2 and thus can play the video 2. In this way, before the server sends the video to the terminal device, the definition of the video can be improved, and then the playing effect of the video can be enhanced.

It needs to be noted that FIG. 1 just exemplarily illustrates the application scenario of the embodiment of the present disclosure and not defines the application scenarios of the embodiments of the present disclosure.

In the related art, the pre-processing of the video can effectively improve the quality of the video. For example, before the server sends the video to the terminal device, super-resolution processing may be performed on the video so that the resolution of the video can be increased. At present, a server may perform pre-processing on a video based on a video processing model. For example, the server may perform super-resolution processing on the video based on a trained video super-resolution model, thereby obtaining a video after the super-resolution processing, wherein the definition of the video after the super-resolution processing is greater than that of the video before the super-resolution processing. However, before sending the processed video to the terminal device, the server also needs to encode the video, and part of information in the video may be lost after encoding. Consequently, the video processing model does not learn the distorted information of video encoding at the training stage, which in turn results in poor accuracy of video processing.

In order to solve the technical problem in the related art, an embodiment of the present disclosure provides a video processing method. The electronic device may acquire a first video and process the first video based on a video processing model to obtain a second video. The electronic device may encode the second video, wherein the video processing model is trained based on the following steps: acquiring a sample video, a target video corresponding to the sample video, and a target code rate of the target video; processing the sample video based on the video processing model to obtain a first predicted video; processing the first predicted video based on the differentiable encoder to obtain a second predicted video and a predicted code rate; and training the video processing model based on the second predicted video, the target video, the predicted code rate, and the target code rate. In this way, since the differentiable encoder is capable of simulating quantization and encoding processes performed by an encoder on a video and the differentiable encoder is capable of performing gradient backpropagation, the differentiable encoder can aid the video processing model in learning the distorted information after video encoding. The training accuracy of the video processing model can be improved, and then the accuracy of video processing can be improved.

Detailed descriptions on the technical solutions of the present disclosure and how to solve the above technical problem will be described below with specific embodiments. The following specific embodiments may be combined with each other, and the same or similar concepts or processes may not be repeatedly described in some embodiments. The embodiments of the present disclosure will be described in detail below with reference to the drawings.

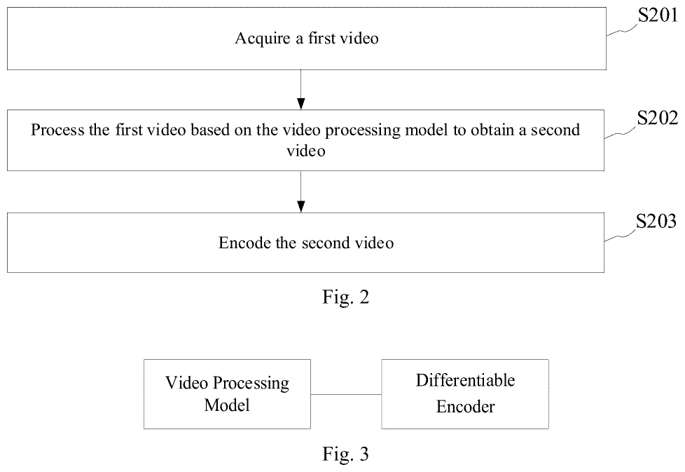

FIG. 2 is a flowchart of a video processing method provided by an embodiment of the present disclosure. Referring to FIG. 2, the video processing method may include the steps as follows.

In S201, a first video is acquired.

An executing entity of the embodiments of the present disclosure may be an electronic device, or may be a video processing apparatus in the electronic device. The video processing apparatus may be implemented based on software, or the video processing apparatus may be implemented based on a combination of software and hardware, which will not be limited in the embodiments of the present disclosure.

The electronic device may be any device having a terminal computing capability. For example, the electronic device may be a server, a computer, et., which will not be limited in the embodiments of the present disclosure.

In an exemplary embodiment, the first video may be a video to be processed. For example, the first video may be a video to be subjected to super-resolution processing. The first video may also be a video to be subjected to object tracking. This will not be limited in the embodiments of the present disclosure.

In an exemplary embodiment, the electronic device may also receive a first video sent by other devices. For example, after shooting a video, the terminal device may send the shot video to the server, and the server may determine the video as the first video.

In an exemplary embodiment, the electronic device may acquire the first video from a database. For example, the database may prestore a plurality of videos. When the server needs to process videos, a plurality of first videos may be acquired from the database.

It needs to be noted that the electronic device may acquire the first video based on any feasible implementation, which will not be limited in the embodiments of the present disclosure.

In S202, the first video is processed based on the video processing model to obtain a second video.

The video processing model may be configured to process a video. For example, if the video processing model is the super-resolution model, the video processing model may perform super-resolution processing on a video. If the video processing model is an object tracking model, the video processing model may track an object in a video, etc.

It needs to be noted that the video processing model in the embodiments of the present disclosure may be a model having any video processing function, which will not be limited in the embodiments of the present disclosure.

The second video may be a video after processing the first video. For example, the video processing model may be a pre-trained model. After the electronic device inputs the first video to the video processing model, the second video corresponding to the first video may be obtained. For example, if the video processing model is the super-resolution model, the electronic device may input the first video to the video processing model, the video processing model may perform super-resolution processing on the first video to obtain the second video, wherein the definition of the second video is greater than that of the first video.

A training stage of the video processing model may include a differentiable encoder. For example, the training stage of the video processing model may include the differentiable encoder. Since the differentiable encoder may perform model training, the video processing model may learn information about coding distortion based on the output results of the differentiable encoder during the training stage. Thus, the training accuracy of the video processing model can be improved.

The differentiable encoder may be used to simulate quantization and encoding processes of a video by an encoder, and the differentiable encoder is capable of performing gradient backpropagation. For example, the differentiable encoder may simulate the encoding processing process of the video by an encoder. Therefore, the electronic device may acquire a loss caused by the encoding process on the video based on the differentiable encoder. Moreover, since the differentiable encoder is capable of performing gradient backpropagation, when the video processing model is trained, the differentiable encoder is capable of performing gradient backpropagation to the video processing model. In turn, model parameters in the video processing model are trained, and the accuracy of model training is improved.

A structure for the training stage of the video processing model is described below with reference to FIG. 3.

FIG. 3 is a structural schematic diagram of a training stage of a video processing model provided by an embodiment of the present disclosure. Referring to FIG. 3, a video processing model and a differentiable encoder are involved. An output end of the video processing model may be connected with an input end of the differentiable encoder. In this way, in the process of training the video processing model, since the differentiable encoder is capable of performing gradient backpropagation, the video processing model may learn information about distortion caused by video encoding. Thus, the training accuracy of the video processing model can be improved. When the video processing model is used, the accuracy of video processing can be improved.

In S203, the second video is encoded.

In an exemplary embodiment, the electronic device, after acquiring the second video, may encode the second video. For example, the electronic device may encode the second video based on any feasible standard encoding mode, and the electronic device, after encoding the second video, may send a code of the second video to the terminal device. The terminal device, after receiving the code of the second video, may decode the code and display the second video.

The embodiments of the present disclosure provide a video processing method. The electronic device may acquire a first video and process the first video based on the video processing model to obtain a second video. The electronic device may encode the second video. The training stage of the video processing model includes the differentiable encoder. Since the differentiable encoder is capable of simulating the quantization and encoding processes of a video by an encoder and the differentiable encoder is capable of performing gradient backpropagation, at the training stage of the video processing model, the video processing model can learn distorted information after the encoder encodes the video. In this way, the accuracy of the video processing model can be improved, and the accuracy of video processing can be improved.

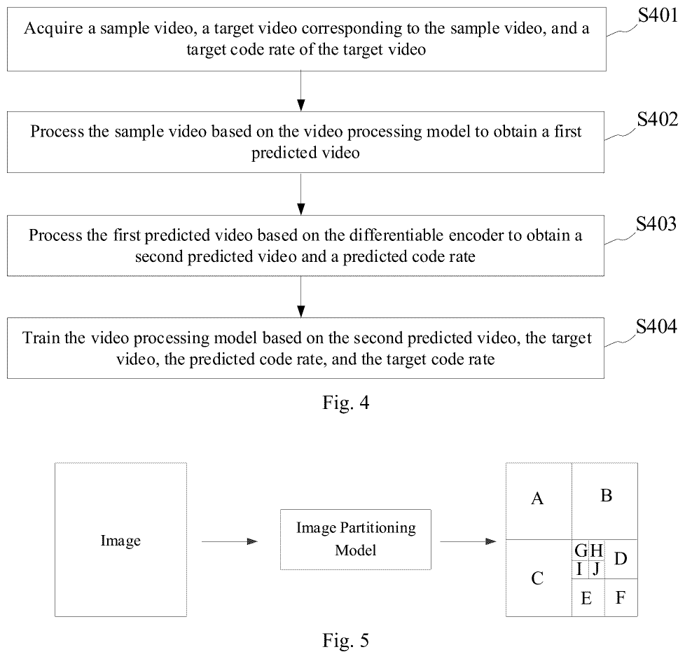

On the basis of the embodiment shown in FIG. 2, the video processing method may further include a method of training the video processing model. The method of training the video processing model is described in detail below with reference to FIG. 4.

FIG. 4 is a schematic diagram of a method of training a video processing model provided by an embodiment of the present disclosure. Referring to FIG. 4, the process of the method includes the steps as follows.

In S401, a sample video, a target video corresponding to the sample video, and a target code rate of the target video are acquired.

In an exemplary embodiment, the sample video may be any video. For example, if the video processing model is the super-resolution model, the sample video may be a low-resolution video. If the video processing model is the object tracking model, the sample video may include an object to be tracked.

It needs to be noted that the electronic device may acquire the sample video based on the function of the video processing model. The electronic device may also acquire the sample video based on any feasible implementation, which will not be limited in the embodiments of the present disclosure.

The target video may be a video corresponding to the sample video. For example, if the video processing model is the super-resolution model, the sample video may be a low-resolution video and the target video may be a high-resolution video corresponding to the sample video, wherein a video content in the target video is the same as that in the sample video.

In an exemplary embodiment, the target code rate may be a code rate of the target video. For example, in the training process of the video processing model, the video processing model may be enabled to learn encoding distorted information at different code rates based on the target code rate of the target video. Thus, the training effect of the video processing model can be improved.

It needs to be noted that the electronic device may acquire the sample video, the target video corresponding to the sample video, and the target code rate of the target video based on any feasible implementation, which will not be limited in the embodiments of the present disclosure.

In S402, the sample video is processed based on the video processing model to obtain a first predicted video.

The first predicted video may be a video obtained after the video processing model processes the sample video. In an exemplary embodiment, the electronic device may input the sample video to the video processing model. The video processing model may output the first predicted video corresponding to the sample video.

For example, if the video processing model is the super-resolution model, after the electronic device inputs the sample video to the video processing model, the video processing model may predict a video after super-resolution processing of the sample video based on the sample video, thereby obtaining the first predicted video.

In S403, the first predicted video is processed based on the differentiable encoder to obtain a second predicted video and a predicted code rate.

The second predicted video may be a video after the differentiable encoder encodes the first predicted video. For example, since the differentiable encoder may simulate the quantization and encoding processes of a video by the encoder, the differentiable encoder may acquire distorted information generated when encoding the first predicted video and add up the distorted information and the first predicted video, thereby obtaining the second predicted video.

The predicted code rate may be a code rate at which the differentiable encoder encodes the first predicted video. For example, the differentiable encoder includes an entropy encoding module. The quantized information is processed based on the entropy encoding module so that a predicted code can be obtained.

The electronic device may obtain the second predicted video and the predicted code rate based on the following feasible implementation: performing image partitioning processing on each image in the first predicted video to obtain a plurality of image blocks corresponding to each image; determining an encoding mode corresponding to each image in the first predicted video; encoding each image based on the differentiable encoder, the encoding mode corresponding to each image, and the plurality of image blocks corresponding to each image to obtain the second predicted video and the predicted code rate.

The encoding mode may include intra-frame prediction encoding and inter-frame prediction encoding. For example, the intra-frame prediction encoding may refer to the electronic device encoding an image to be encoded in an image of a current frame based on pixel information in the image of the current frame. The inter-frame prediction encoding may refer to the electronic device encoding an image to be encoded in an image of a current frame based on pixel information in images of adjacent frames.

It needs to be noted that the electronic device may determine the encoding mode corresponding to each image in the first predicted video (e.g., the first image is preset to the intra-frame prediction encoding, the 50th image is preset to the intra-frame prediction encoding, and other images are preset to the inter-frame prediction encoding) based on any feasible implementation, which will not be limited in the embodiments of the present disclosure.

In an exemplary embodiment, each image in the first predicted video may include a plurality of image blocks. For example, for any image in the first video, the electronic device may partition the first video into a plurality of image blocks based on image information, wherein the plurality of image blocks may be the same or different in size, which will not be limited in the embodiments of the present disclosure.

In an exemplary embodiment, the electronic device may process each image in the first predicted video based on the pre-trained image partitioning model, thereby obtaining a plurality of image blocks corresponding to each image. For example, the electronic device may input an image in the first predicted video to the pre-trained image partitioning model. The image partitioning model may perform image partitioning processing on each image.

An image block corresponding to an image is described below with reference to FIG. 5.

FIG. 5 is a schematic diagram of an image block provided by an embodiment of the present disclosure. Referring to FIG. 5, an image and an image partitioning model are involved. The electronic device (not shown in FIG. 5) may input an image to the image partitioning model. The image partitioning model may partition the image into image blocks. The image partitioning model may partition the image into 10 image blocks, wherein image block A, image block B, and image block C have the same size, image block D, image block E, and image block F have the same size, and image block H, image block I, and image block J have the same size. In this way, the electronic device may accurately partition the image into a plurality of image blocks in combination with the image information. Thus, the efficiency of encoding the image by the differentiable encoder can be improved.

It needs to be noted that before the electronic device perform image partitioning processing on the images in the first predicted video, each image may be converted to YUV space (color space). Thus, the image processing effect is enhanced.

For any first image in the first predicted video, there are two cases in which the electronic device encodes each image based on the differentiable encoder, the encoding mode corresponding to each image, and the plurality of image blocks corresponding to each image to obtain the second predicted video and the predicted code rate.

Case 1: the encoding mode is the intra-frame prediction encoding mode.

If the encoding mode is the intra-frame prediction encoding mode, the electronic device may determine a plurality of candidate image blocks corresponding to each image block in the first image, and encode the first image based on each image block and the candidate image blocks corresponding to each image block.

In an exemplary embodiment, for any image block in the first image, if the encoding mode is the intra-frame prediction encoding mode, the electronic device may encode the image block based on pixel information adjacent to the image block. In this way, the electronic device may determine a pixel value in the current frame and predict a value of each pixel within the current frame, thereby reducing redundant information of intra-frame adjacent information. That is, a value of a current pixel is predicted based on pixel values around the current pixel. Thus, the encoding effect can be enhanced.

The process of the electronic device determining a plurality of candidate image blocks corresponding to an image block is described hereinbelow by way of a specific example.

In an exemplary embodiment, the size of the image block is N (an integer greater than 0), and a region to be encoded is N*N. The electronic device may select N*N regions on an upper side, an upper left side, a left side, a left lower side, and an upper right side adjacent to the image block as candidate image blocks.

In an exemplary embodiment, the electronic device may determine a plurality of candidate image blocks based on a single row or a plurality of rows of pixels on the upper side, the left side, the upper left side, the left lower side, and the right side adjacent to the image block. For example, the electronic device may calculate an average value of a single row or a plurality of rows of pixels in each direction, and calculate a difference based on a relative positional relationship with the image block, thereby obtaining the plurality of candidate image blocks. In this way, since the electronic device may determine the candidate image blocks based on the pixel information of the current image, the electronic device may concurrently determine the plurality of candidate image blocks corresponding to each image block. The efficiency of determining the candidate image blocks is improved.

It needs to be noted that the electronic device may determine adjacent image blocks and image blocks calculated based on the average value and interpolation as the candidate image blocks, which will not be limited in the embodiments of the present disclosure.

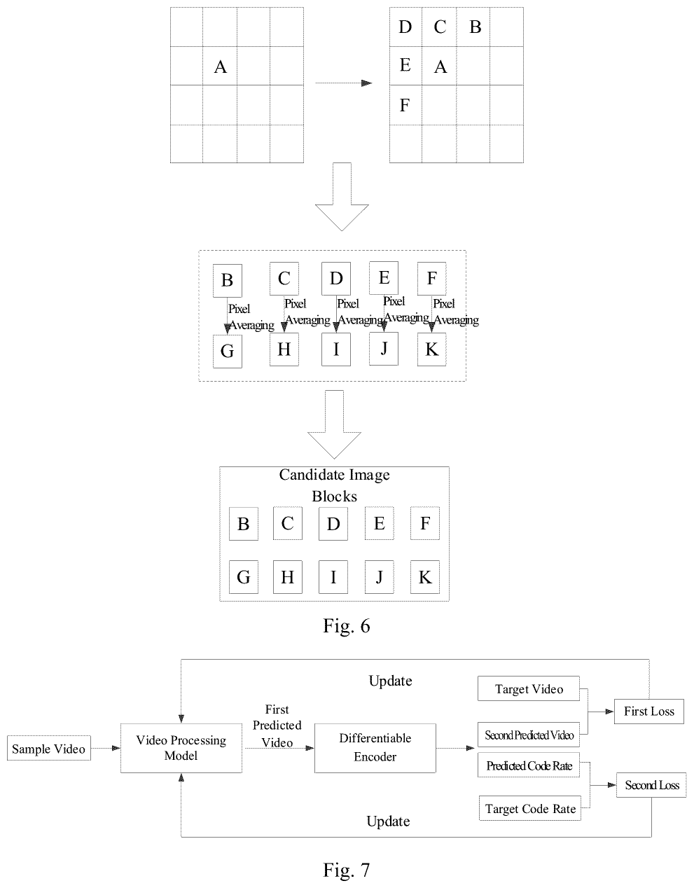

The process of determining the plurality of candidate image blocks corresponding to the image block in this case is described below with reference to FIG. 6.

FIG. 6 is a schematic diagram of determining a plurality of candidate image blocks provided by an embodiment of the present disclosure. Referring to FIG. 6, a first image is involved. The first image includes 16 image blocks, wherein image block A is an image block to be processed. The electronic device (not shown in FIG. 6) may acquire image block B, image block C, image block D, image block e, and image block F, and perform pixel averaging processing on the image block B to obtain image block G, perform pixel averaging processing on the image block C to obtain image block H, perform pixel averaging processing on the image block D to obtain image block I, perform pixel averaging processing on the image block E to obtain image block J, and perform pixel averaging processing on the image block F to obtain image block K. The electronic device may determine the image block B, the image block C, the image block D, the image block E, the image block F, the image block G, the image block H, the image block I, the image block J, and the image block K as the plurality of candidate image blocks for the image block A.

Case 2: the encoding mode is the inter-frame prediction encoding mode.

If the encoding mode is the inter-frame prediction encoding mode, a plurality of candidate image blocks corresponding to each image block of the first image are determined in at least one image adjacent to the first image, and the first image is encoded based on each image block and the plurality of candidate image blocks corresponding to each image block.

In an exemplary embodiment, for any image block in the first image, if the encoding mode is the inter-frame prediction encoding mode, the electronic device may encode the image block in the first image based on pixel information in a plurality of images adjacent to the first image. In this way, a difference between the current frame and a reference frame (an adjacent frame) can be reduced.

In an exemplary embodiment, the electronic device may acquire a plurality of candidate image blocks based on a binary (0, 1) search mask matrix. A search strategy of the binary search mask matrix is a diamond search strategy. If the image block is N*N, the electronic device may map a position in a search space (K*K, K being greater than N) to a binary matrix. Diamond positions to be searched are set to 1, and other positions are set to 0. In this way, ordered search candidate regions corresponding to the image block may be obtained in combination with the reference frame. Also, in order to realize concurrent processing for a plurality of positions, when the search candidate regions are constructed for the image block N*N, for different reference frames, the size is extended to be equal to the size of the candidate search region on the basis of the same region. Thus, the candidate image blocks can be searched concurrently. The processing efficiency can be improved.

It needs to be noted that the electronic device may also determine the plurality of candidate image blocks for the inter-frame prediction encoding (e.g., a half-pixel search manner, etc.) based on any feasible implementation, which will not be limited in the embodiments of the present disclosure.

In an exemplary embodiment, the electronic device may encode the first image based on each image block and the plurality of candidate image blocks corresponding to each image block, and may then encode each image in the first predicted video to obtain the second predicted video and the predicted code rate.

In S404, the video processing model is trained based on the second predicted video, the target video, the predicted code rate, and the target code rate.

In an exemplary embodiment, the electronic device may determine a first loss based on the second predicted video and the target video, determine a second loss based on the predicted code rate and the target code rate, and then train the video processing model based on the first loss and the second loss.

For example, if a first video frame in the second predicted video is image A and a first video frame in a target video is image B, the electronic device may determine the first loss based on the image A and the image B.

It needs to be noted that a loss function in the embodiments of the present disclosure may be any loss function, which will not be limited in the embodiments of the present disclosure.

A training process of the video processing model is described below with reference to FIG. 7.

FIG. 7 is a schematic diagram of a training process of a video processing model provided by an embodiment of the present disclosure. Referring to FIG. 7, a sample video, a target code rate, a target video, a video processing model, and a differentiable encoder are involved. The electronic device (not shown in FIG. 7) may input the sample video to the video processing model. The video processing model may output a first predicted video, and input the first predicted video to the differentiable encoder.

Referring to FIG. 7, the differentiable encoder may encode and decode the first predicted video to obtain a second predicted video and a predicted code rate. The electronic device may determine a first loss based on the second predicted video and the target video, determine a second loss based on the predicted code rate and the target code rate, and then update the video processing model based on the first loss and the second loss. In this way, since the differentiable encoder is capable of performing gradient backpropagation, the video processing model may learn encoding distorted information. Thus, the training accuracy of the video processing model can be improved.

The embodiments of the present disclosure provide a method of training a video processing model, including: acquiring a sample video, a target video corresponding to the sample video, and a target code rate of the target video; processing the sample video based on the video processing model to obtain a first predicted video; processing the first predicted video based on the differentiable encoder to obtain a second predicted video and a predicted code rate; and training the video processing model based on the second predicted video, the target video, the predicted code rate, and the target code rate. In this way, since the differentiable encoder is capable of performing gradient backpropagation, the differentiable encoder can participate in training the video processing model. The video processing model can learn information about the distortion caused by the encoder encoding the video. In this way, the training accuracy of the video processing model can be improved. Moreover, the encoder can concurrently encode the plurality of image blocks in the current image based on the image information before encoding. Therefore, the training efficiency of the video processing model can be improved.

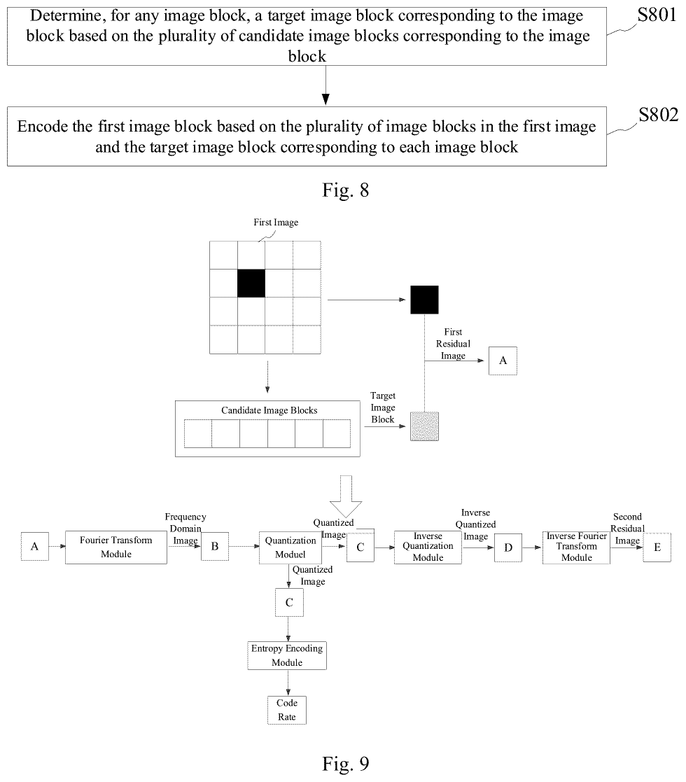

On the basis of the embodiment shown in FIG. 4, a method of encoding the first image based on each image block and the plurality of candidate image blocks corresponding to each image block in the above-mentioned method of training the video processing model is described below with reference to FIG. 8.

FIG. 8 is a schematic diagram of an image encoding method provided by an embodiment of the present disclosure. Referring to FIG. 8, the process of the image encoding method includes the following steps.

In S801, for any image block, a target image block corresponding to the image block is determined based on the plurality of candidate image blocks corresponding to the image block.

In an exemplary embodiment, the electronic device may determine the target image blocks based on the following two feasible implementations.

One feasible implementation is provided as follows.

Convolution processing is performed on the plurality of candidate image blocks to obtain the target image block corresponding to the image block. For example, the electronic device may pre-train an image synthesis model. A training objective of the image synthesis model is to reduce redundant pixel information between a plurality of image blocks. In this way, the plurality of candidate image blocks may be processed based on the image synthesis model to obtain the target image block.

In this way, the electronic device may acquire more pixel information based on the pre-trained model and thus can accurately encode the image.

Another feasible implementation is provided as follows.

The electronic device may determine a residual between the image block and each candidate image block, and determine the candidate image block having a minimum residual with the image block as the target image block. For example, the image block includes candidate image block 1, candidate image block 2, and candidate image block 3. The electronic device determines the residual between the image block and the candidate image block 1 as residual 1, the residual between the image block and the candidate image block 2 as residual 2, and the residual between the image block and the candidate image block 3 as residual 3. If the residual 1 is the minimum, the electronic device may determine the candidate image block 1 as the target image block. If the residual 2 is the minimum, the electronic device may determine the candidate image block 2 as the target image block. If the residual 3 is the minimum, the electronic device may determine the candidate image block 3 as the target image block.

It needs to be noted that the electronic device may determine the residual between the image block and the candidate image block (e.g., by subtraction of image blocks, etc.) based on any feasible implementation, which will not be limited in the embodiments of the present disclosure.

In this way, the residual between the target image block and the image block is small so that the accuracy of encoding can be improved during prediction encoding.

In S802, the first image block is encoded based on the plurality of image blocks in the first image and the target image block corresponding to each image block.

The electronic device may encode the first image based on the following feasible implementation: for any image block, determining a first residual image between the image block and the target image block corresponding to the image block; processing a plurality of first residual images to obtain a plurality of second residual images after encoding of the plurality of first residual images; and obtaining a second image after encoding of the first image based on the plurality of first residual image, the plurality of second residual images, and the first image.

In an exemplary embodiment, the first residual image may indicate a difference between the image block and the target image block. For example, the electronic device may subtract the image block from the target image block to obtain the first residual image corresponding to the image block, wherein each pixel value in the first residual image may represent a pixel difference value between the image block and the target image block.

The second residual image may be an image after the first residual image is encoded and decoded. For example, the electronic device may perform quantization encoding on the first residual image and then decode a quantization result, thereby obtaining the second residual image, wherein a difference between the first residual image and the second residual image may be an encoding loss.

The electronic device may process the plurality of first residual images based on the differentiable encoder to obtain the plurality of second residual images after encoding of the plurality of first residual images. For example, the electronic device may encode and decode the plurality of first residual images based on the differentiable encoder to obtain the plurality of second residual images.

The process that the electronic device processes the plurality of first residual images to obtain the plurality of second residual images after encoding of the plurality of first residual images may include: for any first residual image, performing Fourier transform processing on the first residual image to obtain a frequency domain image corresponding to the first residual image; and performing quantization and rounding processing on the frequency domain image to obtain a quantized image. The electronic device may perform inverse quantization processing on the quantized image to obtain an inverse quantized image, and perform inverse Fourier transform processing on the inverse quantized image to obtain the second residual image corresponding to the first residual image.

The frequency domain image may indicate a frequency domain signal in the first residual image. For example, the frequency domain image may indicate a position of a high-frequency signal and a position of a low-frequency signal in the first residual image, etc. The electronic device may convert the first residual image from space domain to frequency domain based on Fourier transform.

In an exemplary embodiment, the electronic device may determine the frequency domain image corresponding to the first residual image based on any feasible implementation, which will not be limited in the embodiments of the present disclosure.

In an exemplary embodiment, the quantized image may be an image after performing quantization processing on the frequency domain image. For example, the quantization processing may include a quantization operation and a rounding operation. The differentiable encoder may include a quantization module which can perform quantization and rounding processing on the frequency domain image.

A function corresponding to the quantization and rounding processing is a derivable function. For example, the quantization module in the differentiable encoder may include a derivable rounding function. In this way, the quantization operation performed on the image based on the differentiable encoder is differentiable. Therefore, the differentiable encoder is capable of performing gradient backpropagation.

In an exemplary embodiment, the function corresponding to the quantization and rounding processing may be the following function:

$${Q}_{r} = Q + π \frac{- 1}{{\sum }_{n = 1}^{10} \frac{{( - 1 )}^{n + 1}}{n} sin ( 2 π n * Q )}$$

where Qᵣ may be a result after the quantization and rounding processing; n is a preset parameter (which may be set arbitrarily); and Q may be a result after the quantization processing (quantized but not rounded).

In an exemplary embodiment, the inverse quantized image may be an image after performing inverse quantization processing on the quantized image. For example, inverse quantization of the image may be a process of restoring the quantized image. Since part of information will be lost after the quantization and rounding processing, the image quality of the inverse quantized image is lower than that of the quantized image.

In an exemplary embodiment, the electronic device may perform inverse quantization processing on the quantized image based on any feasible implementation, which will not be limited in the embodiments of the present disclosure.

In an exemplary embodiment, the electronic device may perform inverse Fourier transform processing on the quantized image and then converts the inverse quantized image from frequency domain to space domain to obtain the second residual image. The electronic device may convert the inverse quantized image from frequency domain to space domain based on any feasible implementation, which will not be limited in the embodiments of the present disclosure.

In an exemplary embodiment, the electronic device, after obtaining the quantized image corresponding to each first residual image, may further perform entropy encoding processing on a plurality of quantized images associated with the first predicted video to obtain the predicted code rate.

The electronic device may perform entropy encoding processing on the plurality of quantized images based on an entropy encoding model. For example, if the first predicted video includes one hundred (100) of video frame images, the electronic device may determine the quantized image corresponding to each image block in each video frame image, and then process a plurality of quantized images based on the entropy encoding model, thereby obtaining the predicted code rate. The predicted code rate may be a code rate of the second predicted video.

A process of determining the second residual image is described below with reference to FIG. 9.

FIG. 9 is a schematic diagram of a process of determining a second residual image provided by an embodiment of the present disclosure. Referring to FIG. 9, a first image is involved. The first image may include an image block to be encoded (a black region). The electronic device (not shown in FIG. 9) may acquire six (6) candidate image blocks based on the image block to be encoded, and determine a target image block corresponding to the image block to be encoded from the six (6) candidate image blocks.

Referring to FIG. 9, the electronic device may obtain first residual image A based on a residual between the image block to be encoded and the target image block. The electronic device may process the first residual image A based on a Fourier transform module to obtain frequency domain image B, and process the frequency domain image B based on the quantization model to obtain quantized image C.

Referring to FIG. 9, the electronic device may input the quantized image C to the entropy encoding module to obtain a code rate corresponding to the image block to be encoded, and input the quantized image C to an inverse quantization module to obtain inverse quantized image D. The electronic device input the inverse quantized image D to an inverse Fourier transform module to obtain second residual image E. Thus, the electronic device may determine the encoding loss of the encoding process based on the first residual image and the second residual image.

The electronic device, after acquiring a plurality of second residual images, may obtain a second image after encoding of the first image based on the plurality of first residual images, the plurality of second residual images, and the first image. The electronic device may determine the second image based on the following feasible implementation: for any first residual image, determining a difference between the first residual image and the second residual image corresponding to the first residual image to obtain a residual sub-image corresponding to the first residual image; and determining a residual image based on a plurality of residual sub-images, and adding up the first image and the residual image to obtain the second image after encoding of the first image.

In an exemplary embodiment, the residual sub-image may be an image corresponding to the difference between the first residual image and the second residual image. For example, the electronic device may subtract the first residual image from the second residual image to obtain the residual sub-image. The residual sub-image may represent an encoding loss after the first residual image is encoded.

In an exemplary embodiment, the electronic device may splice a plurality of residual sub-images to obtain the residual image. For example, for the first image, the first image may include a plurality of image blocks. Each image block may correspond to one residual sub-image. The electronic device may splice the plurality of residual sub-images based on positions of the image blocks corresponding to the residual sub-images in the first image, thereby obtaining the residual image corresponding to the first image.

In an exemplary embodiment, the electronic device may add up the first image and the residual image to obtain the second image. For example, the residual image corresponding to the first image is an encoding loss after encoding of the first image simulated by the differentiable encoder. Therefore, the electronic device may add up the residual image and the first image to obtain the image after encoding and decoding of the first image.

In this way, the electronic device may determine an encoded image corresponding to each image in the first predicted video, thereby obtaining a second predicted video, and the electronic device may obtain a code rate of the second predicted video based on the entropy encoding module. In this way, the video processing model may learn the loss of image encoding in the training process. The training accuracy of the video processing model can be improved.

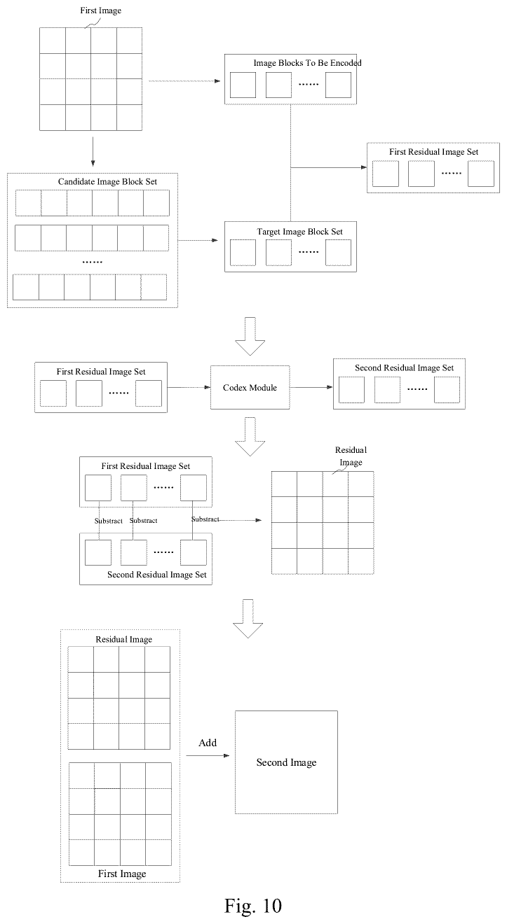

A process of generating the second image is described below with reference to FIG. 10.

FIG. 10 is a schematic diagram of a process of generating a second image provided by an embodiment of the present disclosure. Referring to FIG. 10, a first image is involved. The first image includes sixteen (16) image blocks to be encoded. The electronic device (not shown in FIG. 10) may determine a candidate image block set based on sixteen (16) image blocks to be encoded. The candidate image block set includes sixteen (16) sets of candidate image blocks. Each set of candidate image blocks includes six (6) candidate image blocks. Each set of candidate image blocks corresponds to one image block to be encoded.

Referring to FIG. 10, the electronic device may determine a target image block in each set of candidate image blocks, thereby obtaining a target image block set. The target image block set includes sixteen (16) target image blocks, and each target image block corresponds to the image block to be encoded. The electronic device may obtain a first residual image set based on differences between the image blocks to be encoded and the target image blocks corresponding to the image blocks to be encoded, wherein the first residual image set includes sixteen (16) first residual images.

Referring to FIG. 10, the electronic device may input the first residual image set to a codex module (the processing steps of the codex module may be similar to the processing steps in the embodiment shown in FIG. 9, which will not be described redundantly in the embodiments of the present disclosure). The codex module may determine the second residual image corresponding to each first residual image, thereby obtaining a second residual image set.

Referring to FIG. 10, the electronic device may subtract sixteen (16) first residual images from sixteen (16) second residual image images (which may be based on positions) to obtain a residual image. The residual image may represent the encoding loss after the first image is encoded. Therefore, the electronic device may add up the residual image and the first image to obtain the second image after encoding of the first image. In this way, the electronic device may concurrently encode all the image blocks in the first image based on the differentiable encoder. The electronic device may acquire the residual image corresponding to each image in time. Thus, the training efficiency of the video processing model can be improved.

In an exemplary embodiment, the electronic device may further include a partitioning method for image blocks. If the size of the image block is M*K, a partitioning size for the image block may include 4, 8, 16, 32, and 64. The electronic device may partition the image into N*N image blocks based on the partitioning size of each image block (a boundary region less than N*N may be supplemented to N*N in a boundary value filling manner).

The electronic device may determine the first residual images corresponding to a plurality of image blocks in each partitioning manner, and then determine a partitioning manner for image blocks based on comparison of the first residual images in each partitioning manner. For example, the electronic device may partition an image (having the size of M*K) into four (4) blocks and eight (8) blocks. For the 4-block partitioning manner, the electronic device may determine the first residual image corresponding to each image block, thereby obtaining four (4) first residual images. For the 8-block partitioning manner, the electronic device may determine the first residual image corresponding to each image block, thereby obtaining eight (8) first residual images. The electronic device may perform conversion processing on four (4) first residual images to obtain (M/4)*(K/4) target residual image. The electronic device may perform conversion processing on eight (8) first residual images to obtain (M/8)*(K/8) target residual image. Since the two target residual images have different sizes, the electronic device may perform summation processing on values in the (M/4)*(K/4) target residual image and then perform size alignment on the (M/4)*(K/4) target residual image and the (M/8)*(K/8) target residual image. For any region, the electronic device may determine the partitioning manner corresponding to the region having the minimum residual as the partitioning manner for the image. For example, for a first region in the 4*4 partitioned image, a first predicted residual corresponding to an image block in the first region is residual 1. For a second region (corresponding to the first region in position) in the 8*8 partitioned image, the first predicted residual corresponding to an image block in the second region is residual 2. If the residual 1 is less than the residual 2, the image partitioning manner for the region is 4*4.

The embodiments of the present disclosure provide an image encoding method. For any image block, a target image block corresponding to the image block is determined based on the plurality of candidate image blocks corresponding to the image block. For any image block, a first residual image between the image block and the target image block corresponding to the image block is determined. A plurality of first residual images are processed to obtain a plurality of second residual images after encoding of the plurality of first residual images. A second image after encoding of the first image is obtained based on the plurality of first residual image, the plurality of second residual images, and the first image. In this way, since the function for quantization and rounding is a derivable function, the differentiable encoder can perform gradient backpropagation. The video processing model can learn an encoding loss after video encoding so that the training accuracy of the video processing model can be improved. Also, the differentiable encoder can concurrently encode a plurality of image blocks in the current image. The efficiency of acquiring the residual image corresponding to each image can be improved. Thus, the training efficiency of the video processing model can be improved.

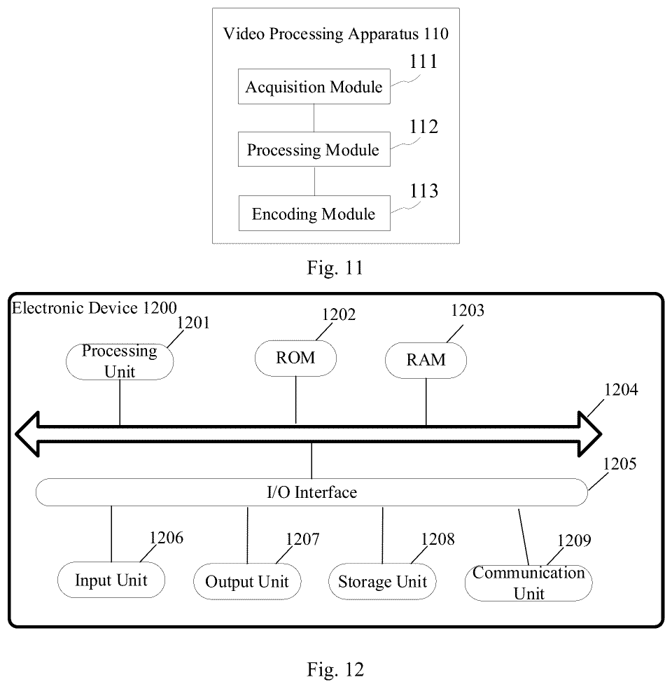

FIG. 11 is a structural schematic diagram of a video processing apparatus provided by an embodiment of the present disclosure. Referring to FIG. 11, the video processing apparatus 110 includes an acquisition module 111, a processing module 112, and an encoding module 113.

The acquisition module is configured to acquire a first video.

The processing module is configured to process the first video based on a video processing model to obtain a second video, wherein a training stage of the video processing model includes a differentiable encoder being configured to simulate quantization and encoding processes performed by an encoder on a video, and the differentiable encoder is capable of performing gradient backpropagation.

The encoding module is configured to encode the second video.

According to one or more embodiments of the present disclosure, the video processing apparatus 110 further includes a training module 114. The training module 114 is configured to: acquire a sample video, a target video corresponding to the sample video, and a target code rate of the target video; process the sample video based on the video processing model to obtain a first predicted video; process the first predicted video based on the differentiable encoder to obtain a second predicted video and a predicted code rate; and train the video processing model based on the second predicted video, the target video, the predicted code rate, and the target code rate.

According to one or more embodiments of the present disclosure, the training module 114 is also configured to: perform image partitioning processing on each image in the first predicted video to obtain a plurality of image blocks corresponding to each image; determine an encoding mode corresponding to each image in the first predicted video, wherein the encoding mode includes intra-frame prediction encoding and inter-frame prediction encoding; and encode each image based on the differentiable encoder, the encoding mode corresponding to each image, and the plurality of image blocks corresponding to each image to obtain the second predicted video and the predicted code rate.

According to one or more embodiments of the present disclosure, the training module 114 is also configured to, for any first image in the first predicted video: if the encoding mode is the intra-frame prediction encoding, determine a plurality of candidate image blocks corresponding to each image block in the first image, and encode the first image based on each image block and the plurality of candidate image blocks corresponding to each image block; and if the encoding mode is the inter-frame prediction encoding, determine, in at least one image adjacent to the first image, a plurality of candidate image blocks corresponding to each image block of the first image, and encode the first image based on each image block and the plurality of candidate image blocks corresponding to each image block.

According to one or more embodiments of the present disclosure, the training module 114 is also configured to: for any image block, determine a target image block corresponding to the image block based on the plurality of candidate image blocks corresponding to the image block; and encode the first image block based on the plurality of image blocks in the first image and the target image block corresponding to each image block.

According to one or more embodiments of the present disclosure, the training module 114 is also configured to: perform convolution processing on the plurality of candidate image blocks to obtain the target image block corresponding to the image block; or determine a residual between the image block and each candidate image block, and determine the candidate image block having a minimum residual with the image block as the target image block.

According to one or more embodiments of the present disclosure, the training module 114 is also configured to: for any image block, determine a first residual image between the image block and the target image block corresponding to the image block; process a plurality of first residual images to obtain a plurality of second residual images after encoding of the plurality of first residual images; and obtain a second image after encoding of the first image based on the plurality of first residual image, the plurality of second residual images, and the first image.

According to one or more embodiments of the present disclosure, the training module 114 is also configured to: for any first residual image, determine a difference between the first residual image and the second residual image corresponding to the first residual image to obtain a residual sub-image corresponding to the first residual image; and determine a residual image based on a plurality of residual sub-images, and add up the first image and the residual image to obtain the second image after encoding of the first image.

According to one or more embodiments of the present disclosure, the training module 114 is also configured to, for any first residual image: perform Fourier transform processing on the first residual image to obtain a frequency domain image corresponding to the first residual image; perform quantization and rounding processing on the frequency domain image to obtain a quantized image, wherein a function corresponding to the quantization and rounding processing is a derivable function; perform inverse quantization processing on the quantized image to obtain an inverse quantized image; and perform inverse Fourier transform processing on the inverse quantized image to obtain the second residual image corresponding to the first residual image.

According to one or more embodiments of the present disclosure, the training module 114 is further configured to: perform entropy encoding processing on a plurality of quantized images associated with the first predicted video to obtain the predicted code rate.

The video processing apparatus provided in the embodiments of the present disclosure may be configured to perform the technical solutions of the method embodiments described above, and may follow similar implementation principles and have similar technical effects to the method embodiments, which will not be redundantly described herein.

FIG. 12 is a structural schematic diagram of an electronic device provided by an embodiment of the present disclosure. Referring to FIG. 12, there is shown the schematic structural diagram of the electronic device 1200 adapted to implement embodiments of the present disclosure. The electronic device may include, but be not limited to, mobile terminals such as a mobile phone, a notebook computer, a digital streaming receiver, a personal digital assistant (PDA), a portable Android device (PAD), a portable media player (PMP), and a vehicular terminal (e.g., a vehicular navigation terminal), and fixed terminals such as a digital TV and a desktop computer. The electronic device shown in FIG. 12 is merely an example, and should not impose any limitation to the functions and the range of use of the embodiments of the present disclosure.

As shown in FIG. 12, the electronic device 1200 may include a processing unit (e.g., a central processing unit, or a graphics processing unit) 1201, which can perform various suitable actions and processing according to a program stored on a read-only memory (ROM) 1202 or a program loaded from a storage unit 1208 into a random-access memory (RAM) 1203. The RAM 1203 further stores various programs and data required for operations of the electronic device 1200. The processing unit 1201, the ROM 1202, and the RAM 1203 are interconnected by means of a bus 1204. An input/output (I/O) interface 1205 is also connected to the bus 1204.

Usually, the following units may be connected to the I/O interface 1205: an input unit 1206 including, for example, a touch screen, a touch pad, a keyboard, a mouse, a camera, a microphone, an accelerometer, and a gyroscope; an output unit 1207 including, for example, a liquid crystal display (LCD), a loudspeaker, and a vibrator; a storage unit 1208 including, for example, a magnetic tape and a hard disk; and a communication unit 1209. The communication unit 1209 may allow the electronic device 1200 to be in wireless or wired communication with other devices to exchange data. While FIG. 12 illustrates the electronic device 1200 having various units, it is to be understood that all the illustrated apparatuses are not necessarily implemented or included. More or less units may be implemented or included alternatively.

According to the embodiments of the present disclosure, the process described above with reference to the flowchart may be implemented as a computer software program. For example, an embodiment of the present disclosure includes a computer program product including a computer program carried by a computer-readable medium. The computer program includes a program code for executing the method shown in the flowchart. In such an embodiment, the computer program may be downloaded online through the communication unit 1209 and installed, or installed from the storage unit 1208, or installed from the ROM 1202. When the computer program is executed by the processing unit 1201, the functions defined in the method of the embodiments of the present disclosure are executed.

It needs to be noted that the computer-readable medium described above in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination of them. More specific examples of the computer-readable storage medium may include, but be not limited to, an electrical connection with one or more wires, a portable computer disk, a hard disk, a random access memory (RAM), a read-only memory (ROM), an erasable programmable read-only memory (EPROM or a flash memory), an optical fiber, a compact disk read-only memory (CD-ROM), an optical storage device, a magnetic storage device, or any appropriate combination thereof. In the present disclosure, the computer-readable storage medium may be any tangible medium that contains or stores a program, and the program may be used by or in combination with an instruction execution system, apparatus, or device. In the present disclosure, the computer-readable signal medium may include a data signal that propagates in a baseband or as a part of a carrier and carries thereon a computer-readable program code. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable storage medium may send, propagate or transmit a program used by or in combination with an instruction execution system, apparatus or device. The program code included on the computer-readable medium may be transmitted by using any suitable medium, including but not limited to an electric wire, a fiber-optic cable, radio frequency (RF) and the like, or any appropriate combination thereof.

The above-mentioned computer-readable medium may be included in the electronic device described above, or may exist alone without being assembled with the electronic device.

The above-mentioned computer readable medium may carry one or more programs which, when executed by the electronic device, cause the electronic device to carry out the method illustrated in the above embodiments.

An embodiment of the present disclosure provides a computer-readable storage medium, storing computer-executable instructions which, when executed by a processor, cause various possibly involved methods in the foregoing embodiments to be implemented.

An embodiment of the present disclosure provides a computer program product, including a computer program which, when executed by a processor, causes various possibly involved methods in the foregoing embodiments to be implemented.

The computer program code for carrying out operations for aspects of the present disclosure may be written in one or more programming languages or their combinations including, but not limited to, object-oriented programming languages such as Java, Smalltalk, C++, and conventional procedural programming languages such as the “C” programming language or similar programming languages. The program code may execute entirely on the user's computer, partly on the user's computer, as a stand-alone software package, partly on the user's computer and partly on a remote computer, or entirely on a remote computer or server. In a scenario involving a remote computer, the remote computer may be connected to the user's computer through any type of network, including a Local Area Network (LAN) or a Wide Area Network (WAN), or may be connected to an external computer (for example, using an Internet Service Provider to connect to the Internet).

The flowcharts and block diagrams in the drawings illustrate the architecture, functionality and operation of possible implementations of systems, methods, and computer program products according to various embodiments of the present disclosure. In this regard, each block in the flowchart or block diagrams may represent a module, segment, or portion of code which comprises one or more executable instructions for implementing the specified logical function(s). It should also be noted that, in some alternative implementations, the functions shown in the blocks might occur out of the order as shown in the figures. For example, two blocks shown in succession may, in fact, be executed substantially concurrently, or the blocks might sometimes be executed in the reverse order, depending on the functionality involved. It should also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

The units involved in the embodiments of the present disclosure may be implemented in software or hardware. The names of these units do not necessarily limit the nature of the units themselves. For example, the “first acquisition unit” could also be described as the “unit for acquiring at least two Internet Protocol addresses”.

The functions described herein may be performed, at least in part, by one or more hardware logic components. For example, and without limitation, illustrative types of hardware logic components that could be used include: Field-Programmable Gate Arrays (FPGAs), Application-Specific Integrated Circuits (ASICs), Application-Specific Standard Products (ASSPs), System-on-a-Chip systems (SOCs), Complex Programmable Logic Devices (CPLDs), etc.

In the context of this disclosure, a machine-readable medium may be a tangible medium that can contain or store a program for use by or in connection with an instruction execution system, apparatus, or device. A machine-readable medium may be a machine-readable signal medium or a machine-readable storage medium. The machine-readable storage medium may include, but is not limited to, electronic, magnetic, optical, electromagnetic, infrared, or semiconductor systems, devices, or apparatus, or any suitable combination of the foregoing. Examples of the machine-readable storage medium may include one or more wire-based electrical connections, portable computer disks, hard drives, random access memory (RAM), read-only memory (ROM), erasable programmable read-only memory (EPROM or Flash memory), fiber optics, portable compact disc read-only memory (CD-ROM), optical storage devices, magnetic storage devices, or any suitable combination of the foregoing.

It should be noted that the terms “a” and “multiple” used in the present disclosure are illustrative rather than restrictive. Those skilled in the art should understand that unless explicitly stated otherwise in the context, these terms should be interpreted as “one or more”.

Names of messages or information exchanged between a plurality of apparatuses in embodiments of the present disclosure are only used for the purpose of description and not meant to limit the scope of these messages or information.

It will be understood that before using the technical solutions disclosed in various embodiments of the present disclosure, a user should be notified of a type, a range of use, a usage scenario, etc. of personal information involved in the present disclosure in an appropriate manner in accordance with relevant laws and regulations, and these should be authorized by the user.

For example, in response to receiving an active request from a user, a prompt message is sent to the user to explicitly prompt the user that the operation the user requests to perform will require to acquire and use the personal information of the user. Thus, the use can independently select, according to the prompt message, whether or not to provide the personal information to software or hardware such as an electronic device, an application, a server or a memory medium that performs the operations of the technical solutions of the present disclosure. As an alternative but non-limiting implementation, in response to receiving an active request from a user, a manner of sending a prompt message to the user may be, for example, using a pop-up window in which the prompt message may be presented in the form of text. Furthermore, the pop-up window may also carry option controls for a user to select to “agree” or “disagree” with providing personal information to an electronic device.

It will be understood that the processes of notifying of and authorizing by a user described above are merely exemplary and do not constitute a limitation on the implementations of the present disclosure, and other manners meeting relevant laws and regulations may also be applied to the implementations of the present disclosure.

It will be understood that data (including but not limited to data itself, and the acquisition and use of data) involved in the present technical solutions should follow corresponding laws and regulations and requirements of relevant stipulations. Data may include information, a parameter, a message, and the like, such as stream cut-in indication information.

The above description merely illustrates the preferred embodiments and the principle of the technology applied in the present disclosure. Those skilled in the art should understand that the scope of the disclosure in the present disclosure is not limited to the technical solutions formed by the specific combination of the aforementioned technical features, but also covers other technical solutions formed by any combination of the aforementioned technical features or their equivalent features under the premise of not departing from the concept of the aforementioned disclosure. For example, technical solutions formed by substituting the aforementioned features with other similar functional technical features disclosed in the present disclosure (but not limited to) should also fall within the scope of protection.

Furthermore, although operations have been depicted in a particular order in the drawings, this should not be understood as requiring that these operations be performed in the illustrated specific order or sequentially in order to achieve desirable results. In certain environments, multitasking and parallel processing may be advantageous. Likewise, although numerous specific details have been set forth in the preceding description in order to provide a thorough understanding of the present disclosure, it will be apparent to one skilled in the art that the present disclosure may be practiced without including all of these specific details. Certain features that are described in the context of separate embodiments may also be combined in a single embodiment. Conversely, various features that are described in the context of a single embodiment may also be implemented in multiple embodiments separately or in any suitable sub-combination.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A video processing method, comprising:
acquiring a first video;
processing the first video based on a video processing model to obtain a second video, wherein a training stage of the video processing model comprises a differentiable encoder which is configured to simulate quantization and encoding processes performed by an encoder on a video, and the differentiable encoder is capable of performing gradient backpropagation; and
encoding the second video.

2. The video processing method according to claim 1, wherein the video processing model is trained based on the following steps:
acquiring a sample video, a target video corresponding to the sample video, and a target code rate of the target video;
processing the sample video based on the video processing model to obtain a first predicted video;
processing the first predicted video based on the differentiable encoder to obtain a second predicted video and a predicted code rate; and
training the video processing model based on the second predicted video, the target video, the predicted code rate and the target code rate.

3. The video processing method according to claim 2, wherein the processing the first predicted video based on the differentiable encoder to obtain a second predicted video and a predicted code rate comprises:
performing image partitioning processing on each image in the first predicted video to obtain a plurality of image blocks corresponding to each image;
determining an encoding mode corresponding to each image in the first predicted video, wherein the encoding mode comprises intra-frame prediction encoding and inter-frame prediction encoding; and
encoding each image based on the differentiable encoder, the encoding mode corresponding to each image, and the plurality of image blocks corresponding to each image to obtain the second predicted video and the predicted code rate.

4. The video processing method according to claim 3, wherein, for any first image in the first predicted video, the encoding each image based on the differentiable encoder, the encoding mode corresponding to each image, and the plurality of image blocks corresponding to each image to obtain the second predicted video and the predicted code rate comprises:
when the encoding mode is the intra-frame prediction encoding, determining a plurality of candidate image blocks corresponding to each image block in the first image, and encoding the first image based on each image block and the plurality of candidate image blocks corresponding to each image block; and
when the encoding mode is the inter-frame prediction encoding, determining, in at least one image adjacent to the first image, a plurality of candidate image blocks corresponding to each image block of the first image, and encoding the first image based on each image block and the plurality of candidate image blocks corresponding to each image block.

5. The video processing method according to claim 4, wherein the encoding the first image based on each image block and the plurality of candidate image blocks corresponding to each image block comprises:
for any image block, determining a target image block corresponding to the image block based on the plurality of candidate image blocks corresponding to the image block; and
encoding the first image block based on the plurality of image blocks in the first image and the target image block corresponding to each image block.

6. The video processing method according to claim 5, wherein the determining a target image block corresponding to the image block based on the plurality of candidate image blocks corresponding to the image block comprises:
performing convolution processing on the plurality of candidate image blocks to obtain the target image block corresponding to the image block; or
determining a residual between the image block and each candidate image block, and determining the candidate image block having a minimum residual with the image block as the target image block.

7. The video processing method according to claim 5, wherein the encoding the first image block based on the plurality of image blocks in the first image and the target image block corresponding to each image block comprises:
for any image block, determining a first residual image between the image block and the target image block corresponding to the image block;
processing a plurality of first residual images to obtain a plurality of second residual images after encoding of the plurality of first residual images; and
obtaining a second image after encoding the first image based on the plurality of first residual image, the plurality of second residual images and the first image.

8. The video processing method according to claim 7, wherein the obtaining a second image after encoding of the first image based on the plurality of first residual image, the plurality of second residual images and the first image comprises:
for any first residual image, determining a difference between the first residual image and the second residual image corresponding to the first residual image to obtain a residual sub-image corresponding to the first residual image; and
determining a residual image based on a plurality of residual sub-images, and adding the first image and the residual image to obtain the second image after encoding the first image.

9. The video processing method according to claim 7, wherein, for any first residual image, the processing a plurality of first residual images to obtain a plurality of second residual images after encoding of the plurality of first residual images comprises:
performing a Fourier transform processing on the first residual image to obtain a frequency domain image corresponding to the first residual image;
performing quantization and rounding processing on the frequency domain image to obtain a quantized image, wherein a function corresponding to the quantization and rounding processing is a derivable function;
performing inverse quantization processing on the quantized image to obtain an inverse quantized image; and
performing an inverse Fourier transform processing on the inverse quantized image to obtain the second residual image corresponding to the first residual image.

10. The video processing method according to claim 9, after obtaining the quantized image, further comprising:
performing entropy encoding processing on a plurality of quantized images associated with the first predicted video to obtain the predicted code rate.

11. An electronic device, comprising:
a processor; and
a memory,
wherein the memory stores computer-executable instructions; and
wherein the computer-executable instructions stored on the memory, when executed by the processor, cause the processor to:
acquire a first video;
process the first video based on a video processing model to obtain a second video, wherein a training stage of the video processing model comprises a differentiable encoder which is configured to simulate quantization and encoding processes performed by an encoder on a video, and the differentiable encoder is capable of performing gradient backpropagation; and
encode the second video.

12. The electronic device according to claim 11, wherein the video processing model is trained based on the following steps:
acquiring a sample video, a target video corresponding to the sample video, and a target code rate of the target video;
processing the sample video based on the video processing model to obtain a first predicted video;
processing the first predicted video based on the differentiable encoder to obtain a second predicted video and a predicted code rate; and
training the video processing model based on the second predicted video, the target video, the predicted code rate and the target code rate.

13. The electronic device according to claim 12, wherein the processing the first predicted video based on the differentiable encoder to obtain a second predicted video and a predicted code rate comprises:
performing image partitioning processing on each image in the first predicted video to obtain a plurality of image blocks corresponding to each image;
determining an encoding mode corresponding to each image in the first predicted video, wherein the encoding mode comprises intra-frame prediction encoding and inter-frame prediction encoding; and
encoding each image based on the differentiable encoder, the encoding mode corresponding to each image, and the plurality of image blocks corresponding to each image to obtain the second predicted video and the predicted code rate.

14. The electronic device according to claim 13, wherein, for any first image in the first predicted video, the encoding each image based on the differentiable encoder, the encoding mode corresponding to each image, and the plurality of image blocks corresponding to each image to obtain the second predicted video and the predicted code rate comprises:
when the encoding mode is the intra-frame prediction encoding, determining a plurality of candidate image blocks corresponding to each image block in the first image, and encoding the first image based on each image block and the plurality of candidate image blocks corresponding to each image block; and
when the encoding mode is the inter-frame prediction encoding, determining, in at least one image adjacent to the first image, a plurality of candidate image blocks corresponding to each image block of the first image, and encoding the first image based on each image block and the plurality of candidate image blocks corresponding to each image block.

15. The electronic device according to claim 14, wherein the encoding the first image based on each image block and the plurality of candidate image blocks corresponding to each image block comprises:
for any image block, determining a target image block corresponding to the image block based on the plurality of candidate image blocks corresponding to the image block; and
encoding the first image block based on the plurality of image blocks in the first image and the target image block corresponding to each image block.

16. The electronic device according to claim 15, wherein the determining a target image block corresponding to the image block based on the plurality of candidate image blocks corresponding to the image block comprises:
performing convolution processing on the plurality of candidate image blocks to obtain the target image block corresponding to the image block; or
determining a residual between the image block and each candidate image block, and determining the candidate image block having a minimum residual with the image block as the target image block.

17. The electronic device according to claim 15, wherein the encoding the first image block based on the plurality of image blocks in the first image and the target image block corresponding to each image block comprises:
for any image block, determining a first residual image between the image block and the target image block corresponding to the image block;
processing a plurality of first residual images to obtain a plurality of second residual images after encoding of the plurality of first residual images; and
obtaining a second image after encoding the first image based on the plurality of first residual image, the plurality of second residual images and the first image.

18. The electronic device according to claim 17, wherein the obtaining a second image after encoding of the first image based on the plurality of first residual image, the plurality of second residual images and the first image comprises:
for any first residual image, determining a difference between the first residual image and the second residual image corresponding to the first residual image to obtain a residual sub-image corresponding to the first residual image; and
determining a residual image based on a plurality of residual sub-images, and adding the first image and the residual image to obtain the second image after encoding the first image.

19. The electronic device according to claim 17, wherein, for any first residual image, the processing a plurality of first residual images to obtain a plurality of second residual images after encoding of the plurality of first residual images comprises:
performing a Fourier transform processing on the first residual image to obtain a frequency domain image corresponding to the first residual image;
performing quantization and rounding processing on the frequency domain image to obtain a quantized image, wherein a function corresponding to the quantization and rounding processing is a derivable function;
performing entropy encoding processing on a plurality of quantized images associated with the first predicted video to obtain the predicted code rate;
performing inverse quantization processing on the quantized image to obtain an inverse quantized image; and
performing an inverse Fourier transform processing on the inverse quantized image to obtain the second residual image corresponding to the first residual image.

20. A non-transitory computer-readable storage medium, storing computer-executable instructions which, when executed by a processor, cause the processor to:
acquire a first video;
process the first video based on a video processing model to obtain a second video, wherein a training stage of the video processing model comprises a differentiable encoder which is configured to simulate quantization and encoding processes performed by an encoder on a video, and the differentiable encoder is capable of performing gradient backpropagation; and
encode the second video.
